(19) United States
(12) Patent Application Publication
(10) Pub. No.: US 2022/0273401 A1
(43) Pub. Date: Sep. 1, 2022

(54) ORTHODONTIC APPLIANCE INCLUDING VIBRATION SOURCE

(71) Applicant: David PENN, Point Piper (AU)

(72) Inventor: David PENN, Point Piper (AU)

(21) Appl. No.: 17/630,951

(22) PCT Filed: Jul. 29, 2020
(86) PCT No.: PCT/AU2020/000074

§ 371 Date: Jan. 28, 2022

(30) Foreign Application Priority Data
Jul. 29, 2019 (AU) 2019902701

(51) Int. Cl. A61C 7/00; A61C 7/08

(52) U.S. Cl. CPC A61C 7/008; A61C 7/08; A61C 2201/00; A61C 2204/002

(57) ABSTRACT

An intra oral removable orthodontic assembly which influences teeth alignment. The assembly comprises; a intraoral attachment fitted to a seating unit and in use, held in place by intraoral engagement of the attachment with crowns of teeth of a wearer. The intraoral attachment is shaped to at least partially conform to at least a dental arch. The seating unit includes a power source, a PCB controller and a source of vibration transmissible to the attachment. The seating device vibrates in response to the source of vibration at a selected frequency between 60 Hz-130 Hz inducing a response in a selected tooth or group of teeth of a wearer. The attachment includes a working head having an array of displaceable formations responsive to said vibration and arranged to engage said teeth.

### BACKGROUND

The present invention relates to a device and method for inducing orthodontic tooth movement and more particularly relates to such devices, assemblies and appliances used for teeth and bite alignment and correction. The invention further relates to a dental appliance which is capable of targeting specific teeth or teeth and areas in the mouth of a user which improves seating of an appliance on a particular tooth or group of teeth for achievement of alignment and other orthodontic objectives. The invention further provides an orthodontic appliance which incorporates a power source and vibration source which in use enhances the targeting of the appliance to particular teeth. The invention further relates to an orthodontic device with a variety of attachments which enables improved capture, encapsulation and selection of teeth for therapy and which is capable of orientation in a variety of attitudes and user selected working states to facilitate the capture of a targeted tooth or teeth for alignment or other correction or adjustment.

### PRIOR ART

There are in existence a variety of orthodontic appliances which facilitate teeth alignment, bite correction and dental corrections. Such devices are usually tailored to suit a particular individual although there are other more universal devices which can be adapted or configured to suit a variety of dental patients.

Among the known orthodontic devices are rubberised appliances which are intended to be chewed or bitten into by a user and which aid the seating of the appliance to teeth thereby enhancing the orthodontic devices' programmed movements. For any orthodontic device to function efficiently and effectively, it must fit and maintain accurate contact with teeth as teeth undergo their intended and prescribed movements. One aim is to have an appliance harness the prescribed force application from within to enhance tooth movement. The aim is also to apply accurate forces to an orthodontic device/appliance to intimately seat it, thus allowing the orthodontic device to deliver the correct forces as programmed into the patient's treatment.

Appliances in the ‘Chewy” category—i.e., those that rely for their utility on a user biting into the appliance, require some effort from the user but in time the user may tire from applying the necessary forces to the appliance and so their effectiveness in targeting is reduced. To ameliorate this problem, designers thought to employ vibrational energy also described as high frequency acceleration, so that the combination of chewing and vibration could enhance both the seating of the appliance and promote increased inter-cellular exchange associated with faster tooth movement.

High frequency acceleration or vibrational energy has been employed in the past to accelerate orthodontic tooth movement but the vibration source has been remote and is not ideally located at or in contact with a tooth. Attempts have been made to transfer high frequency acceleration vibrational energy from a remote source to a mouth but this is not an optimal use of the vibrational effects for the purposes intended. Ideally, the vibration source is at or close to the targeted tooth and/or bone treatment site otherwise the strength of the vibration is lost and so to, the anticipated effects. In the past, orthodontic dental vibrators have been held near to the teeth by either a user/patient or another person, cemented to the teeth or arranged to attach to braces fitted to teeth.

Various dental appliances have been described in the following publications: US patent application 20099061375 Yamamoto; US2014335467 Panasonic; US 2015182305 Orthoaccel Technologies; WO2017083880 Smile Lab Inc.

Yamamoto 20099061375 describes an orthodontic appliance capable of aligning teeth without use of braces. The appliance has a mouthpiece mountable on teeth and an associated vibrating element. The appliance is shaped to apply a biasing force in an aligning direction to a tooth to be aligned in a teeth array. The vibrating element is attached to the appliance and generates mechanical vibration in the tooth to be aligned. The appliance is mounded to the shape of the wearer's teeth array with the vibration source mounted on the anterior surface of the appliance. This appliance restricts the effects of vibration as the appliance is pre moulded so the interface/point of contact between the appliance and a tooth cannot adjust its local geometry to accommodate, influence and track and adjust tooth movements as they occur.

US2014335467 Panasonic Health Care teaches a vibrating dental device which vibrates a specific tooth when connected to a wire or mouthpiece attached to a tooth. Panasonic aims to provide a small and lightweight vibrating dental device which is easily attached and detached to and from an appliance attached to a tooth. This appliance allows transmission of vibration to a front face of a tooth but limits the effect of the vibrations on the tooth. The interface/point of contact between the appliance and a tooth cannot adjust its local geometry to optimally accommodate, influence and track and adjust to tooth movements as they occur.

US 2015182305 Orthoaccel Technologies discloses a disposable peel and stick vibrating orthodontic device such as aligners aimed at accelerating dental remodelling. The peel and stick vibrating strip can be attached to existing orthodontic devices such as aligners, positioners, fixed appliances. It may also be attached directly to teeth. The device described is a means of applying a vibration to teeth which facilitates remodelling but it does not and cannot at the point of the interface/point of contact between the appliance and a tooth, adjust its local geometry to optimally accommodate, influence and track and adjust to tooth movements as they occur.

WO2017083880 Smile Lab Inc: this publication discloses a vibrating device for delivering energy to at least a portion of a dental device. The vibrating element maybe inserted into a biting element or attached to a biting element to apply vibrations to aid in alignment of a user's teeth. The user bites on the appliance and a source of vibration is generated. The device described is a means of applying a vibration to teeth which facilitates remodelling but it does not and cannot at the point of the interface/point of contact between the appliance and a tooth, adjust its local geometry to optimally accommodate, influence and track and adjust to tooth movements as they occur.

Whilst the cited prior art documents each teach a combination of a dental appliance and source of vibration, there is little direction as to optimisation of the effects of vibration on teeth, particularly at the microscopic level. More specifically there is little or no teaching of the local effects at an interface between the appliance and tooth induced by the vibrations. Nor is there any teaching of how local application of forces to teeth from different angles can be achieved and are harnessed and how these impact on tooth movement/adjustment. Each of the prior art documents is typified by the rigidity of the appliance. Some conform to teeth geometry but others to not. The prior art devices do little more than transmit vibrations to teeth using rigid structures which do not optimally apply forces to teeth nor accommodate teeth adjustment responses. An Acceledent™ device offers several different bite plates for different bite shapes, but this is also rigid.

There is a long felt want to provide an assembly which satisfies the objective of seating the orthodontic force appliance (aligner) most effectively, but provides a versatile assembly enabling a user to choose from a wide variety of working attachments/heads which deliver vibrational forces close to the target site to optimise orthodontic tooth movement. More specifically there is a need to provide a device which delivers vibrational forces to each tooth, and thus simultaneously and symmetrically within the segment that each attachment is designed for.

### INVENTION

Outlined broadly below are embodiments and features of the invention to enable it be better understood, and in order that the present contribution to and improvement over the current art may be better appreciated. There are, of course, additional features of the invention that will be described hereinafter and which will form the subject matter of the claims.

In this respect, before explaining at least one embodiment of the invention in detail, it is to be understood that the invention is not limited in its application to the details of construction and to the arrangements of the components as set forth in the following description or illustrated in the drawings. The invention is capable of other embodiments and of being practiced and carried out in various ways in various anatomical sites including veterinary applications.

Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other variations on the assemblies, structures, methods and systems for carrying out the purposes of the present invention.

It is therefore an object of the present invention to provide a new and improved assembly, associated devices and kit which improves the utility of orthodontic appliances used in alignment and teeth therapies and to enable targeting of individual teeth and/or a group/segment of teeth simultaneously and symmetrically with optimal application of forces and which ameliorates the practical disadvantages encountered in use of the known appliances.

With the aforesaid prior art problems and disadvantages of current methodologies, the present invention provides for an improvement in efficacy of devices used in dentistry and in particular, orthodontic dentistry. The device which can be re-useable, efficient, safe and simple to use and at the same time protective of oral and peri-oral tissues. More particularly the invention provides a device which is patient friendly and improves the specific targeting of teeth through improved adjustment or orientation and seating and at a user's election, combining mechanical therapy with localised vibrations.

In one broad form the present invention comprises:

an intra oral removable orthodontic assembly which influences teeth adjustment; the assembly comprising;
a intraoral attachment fitted to a seating unit and in use, held in place by intraoral engagement of the attachment with crowns of teeth of a wearer;
the intraoral attachment shaped to at least partially conform to at least part of a dental arch;
the seating unit including a power source, a PCB controller and a source of vibration transmissible to the attachment;
wherein said seating device vibrates in response to said source of vibration at a selected frequency between 60 Hz-130 Hz inducing a response in a selected tooth or group of teeth of a wearer; characterised in that the attachment includes a working head having an array of displaceable formations arranged to engage said teeth and responsive to said vibration.

According to one embodiment the seating unit is a hub or base unit which receives various working heads as attachments. According to one embodiment a housing receives and retains in the internal space a vibration source with the vibration source connected to a local or remote power source which is capable of inducing vibration to the assembly and by transfer to teeth and supporting bone. According to a preferred embodiment each device is battery operated and recharged in a specially designed charging case. Preferably nodules engage all teeth simultaneously and symmetrically but it will be appreciated by persons skilled in the art that nodules could act individually and asymmetrically.

According to a preferred embodiment, the housing has three radial arms which receive and detachably retain user selected working heads. The radial arms are preferably arranged similar to spokes in a wheel but alternative arrangements are contemplated. A reference to a working head can be taken to include a reference to a therapeutic dental device including devices known as bite or wafer plates and which has a formation or formations which interact with a tooth or teeth and which harness optimally teeth movement forces to enhance prescribed orthodontic tooth movement. The working head preferably includes nodules, formations or grooves which co operate with a tooth or teeth to accelerate/enhance alignments. According to one embodiment, the working head may employ top grooves, bottom grooves, top and underside nodules and there may be a combination of grooves and nodules on the one working head. The working heads target specific teeth or areas of multiple teeth and assist seating of the orthodontic device for interaction with targeted teeth.

Preferably, when radial arms are employed, those radial arms are arranged so they are spaced at 120 degrees, allowing a user to select mouth insertion of 1, 2 or 3 working heads. Each arm has formations which allow detachable engagement with a working head. The formations enable engagements such as snap fit, screw on, spring locked, and is preferably a male-female engagement.

According to one embodiment the vibration source is a motor operable by the power source. The power source is either self-contained internally within the housing or remote such as may be supplied from a power point. The power source may comprise a rechargeable or disposable battery contained inside or external of the housing.

According to one embodiment, the body of the assembly is manufactured from plastics materials of the same or different hardness. Preferably the selected materials for the working ends of the working heads are rubberised or placticised (for example, viscoelastic or elastomeric) to allow elastic (or plastic) deformation.

According to one embodiment the assembly comprises a central body forming the housing and extending radially therefrom are arms which include distal formations which detachably receive and retain selected working heads. A user may select from multiple head types depending upon the therapy required, type of teeth to be targeted with the device and the location in the mouth that the teeth are to be targeted. Various working heads are contemplated including heads to target anterior teeth, posterior teeth, top and bottom teeth. Each working head may be manufactured from materials having a particular hardness suitable for the user requirements.

Different hardnesses of the working heads are contemplated to satisfy different therapeutic use characteristics and different patients. According to one embodiment there are three radially disposed arms which are spaced at 120 degrees. Each arm is capable of receiving a working head which may be the same or different depending upon user selections for purpose. For example one head is selective to anterior teeth, another selective to posterior teeth and another selective to a particular tooth type (eg molar, incisor, canine etc). The radial array of working heads allows the assembly to target teeth by a combination of orientation of the device or by selection of a working head suitable to target a particular tooth or selection of teeth and while delivering a selected vibrational frequency.

Preferably the body of the device is manufactured from materials selected from plastics, rubber, metals or a combination of those. The device may be manufactured from other materials which are preferably pliable or plastic, but electrically inert to avoid unwanted conductivity. According to a preferred embodiment a user can select whether to use an assembly which includes a vibration source or one that does not offer vibration to enhance teeth selection. The shape of the assembly and each working head is based on the use of the heads inside a user's mouth so it must fit comfortably within the mouth space. In this regard the device is capable of location or seating within the mouth such that it accommodates patient mouth anatomy.

In another broad form the present invention comprises: an orthodontic movement enhancement assembly insertable in a user's mouth for use in accelerating teeth alignment corrections; the assembly comprising a central body including a housing defining an internal space, and extending therefrom at least one connecting arm configured to receive and retain thereon a detachable working head; wherein said at least one working head is in use, capable of selective interaction with one or more teeth to facilitate seating on said one or more teeth; the assembly including a source of vibration and formations on the working heads which respond to vibrations induced by the vibration source and move, displace or deform on contact with a tooth or teeth array.

Preferably the at least one connecting arm/s are radially arranged and receive the working heads by axial engagement. Teeth alignment corrections are usually referred in the industry as Orthodontic Tooth movement (OTM)

In another broad form, the present invention comprises:

an orthodontic assembly insertable in a user's mouth for use in teeth alignment corrections; the assembly comprising a central body including a housing defining an internal space, and extending from the housing at least one radial connecting arm, each configured to receive and retain thereon a detachable working head; wherein said at least one working head is in use, capable of selective interaction with one or more teeth to facilitate seating on said one or more teeth; the housing including a power source capable of inducing vibration in the assembly for transmission to a user's teeth; the working head including formations which engage said teeth and influence teeth adjustment under an influence of said vibration.

Preferably each working head includes nodules which undergo displacement/deformation to allow for and accommodate intimate contact with the crown of a tooth or crowns of teeth. Preferably the housing includes a switch which allows a user to elect no vibration or vibration. Preferably the housing includes a recharging port to allow recharging of the power source. According to a preferred embodiment, the hub is charged by induction via a charging case.

In another broad form the present invention comprises:

an orthodontic assembly provided in the form of a kit and which is insertable in a user's mouth for use in teeth alignment corrections; the kit comprising an assembly comprising a central body including a housing defining an internal space, and extending therefrom at least one radial connecting arm configured to receive and retain thereon a detachable working head including displaceable formations; the kit including an array of detachable working heads for user selection and wherein said working heads are in use, capable of selective interaction with one or more teeth via said formations which facilitate engagement of the working heads on said one or more teeth.

Preferably the kit is chargeable by induction.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

The present invention provides an alternative to the known prior art and the shortcomings identified. The foregoing and other objects and advantages will appear from the description to follow. In the description reference is made to the accompanying representations, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying illustrations, like reference characters designate the same or similar parts throughout the several views. The following detailed description is, therefore, not to be taken in a limiting sense, and the scope of the present invention is best defined by the appended claims.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIGS. 1a-h show various views of an orthodontic assembly housing body with radial arms for receiving working heads.

FIGS. 2a-g shows various views of a working head attachable to the housing body of FIG. 1.

FIGS. 3 a-g shows various views of an alternative working head attachable to the housing body of FIG. 1.

FIG. 4a-d shows a working head according to an alternative embodiment and which is adapted to connect to a housing body.

FIGS. 5a-g shows a working head according to an alternative embodiment capable of attachment to the housing of FIG. 1.

FIG. 6a-e show an exploded layout of the housing body of FIG. 1 and various working heads selectable for attachment to the housing.

FIG. 7a shows an orthodontic appliance assembly in a working state with three working heads connected to the housing body of FIG. 1.

FIG. 7b shows one working head isolated.

FIG. 8 shows an orthodontic appliance including a housing and working head connected thereto.

FIG. 9 shows a front elevation view of a working head according to one embodiment located adjacent a patient's teeth array.

FIG. 10 shows a side elevation view of a working head according to an alternative embodiment located adjacent a patient's rear teeth array.

### DETAILED DESCRIPTION

The present invention will now be described in more detail according to preferred but non limiting embodiments and with reference to the accompanying illustrations. The examples referred to herein are illustrative and are not to be regarded as limiting the scope of the invention. While various embodiments of the invention have been described herein, it will be appreciated that these are capable of modification, and therefore the disclosures herein are not to be construed as limiting of the precise details set forth, but to avail such changes and alterations as fall within the purview of the description. Throughout the description a refence to a nodule can be taken to include a protrusion, enlargement, formation, cantilever, stem, column, tab, strut, extending from a surface of the attachment.

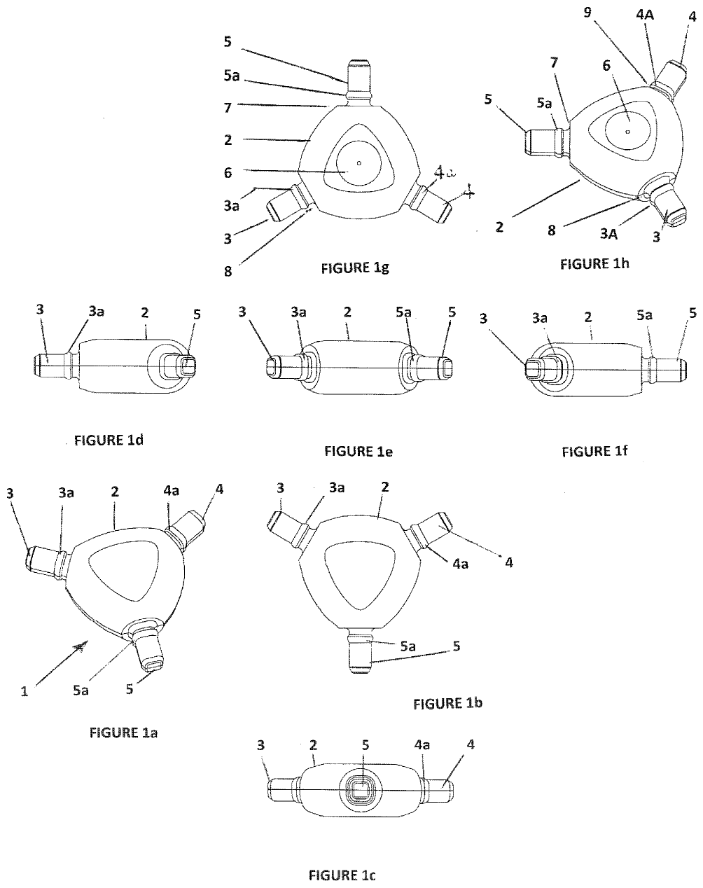

FIGS. 1a-h show a housing 1 which provides a docking station or anchorage for a variety of selected working heads to be described below. Housing 1 comprises a body 2 and extending radially therefrom are connection arms 3, 4 and 5. Arms 3, 4 and 5 respectively include formations 3a, 4a, and 5a which provide engagement with a working head, preferably though not exclusively in snap fit engagement. FIGS. 1c-f show housing 1 rotated clockwise through a horizontal plane gradually presenting features of the housing and arms 3, 4 and 5. FIG. 1g shows the housing body 2 inverted to reveal switch 6 which allows a user to selectively operate a vibration source contained in the housing. According to a preferred embodiment, switch 6 is now rounded recess which requires a user to depress a plastics cover to switch on. Preferably, there are 3 speed choices, elected by pressing down 1, 2, or 3 times consecutively (within 5 sec) to select the speed. Selected speeds are retained in a memory so that a user's speeds are built in when the device is used again. When working heads are received by body 2 each head will engage an opposing abutment surfaces 7, 8 and 9. It will be appreciated by persons skilled in the art that housing body 2 may be provided without a vibration source. In a case where a vibration source is incorporated in the housing, this enhances the operation of the working heads selected for attachment to body 2. Various frequencies may be provide or user selected to achieve optimal operating parameters for each user of the orthodontic appliances.

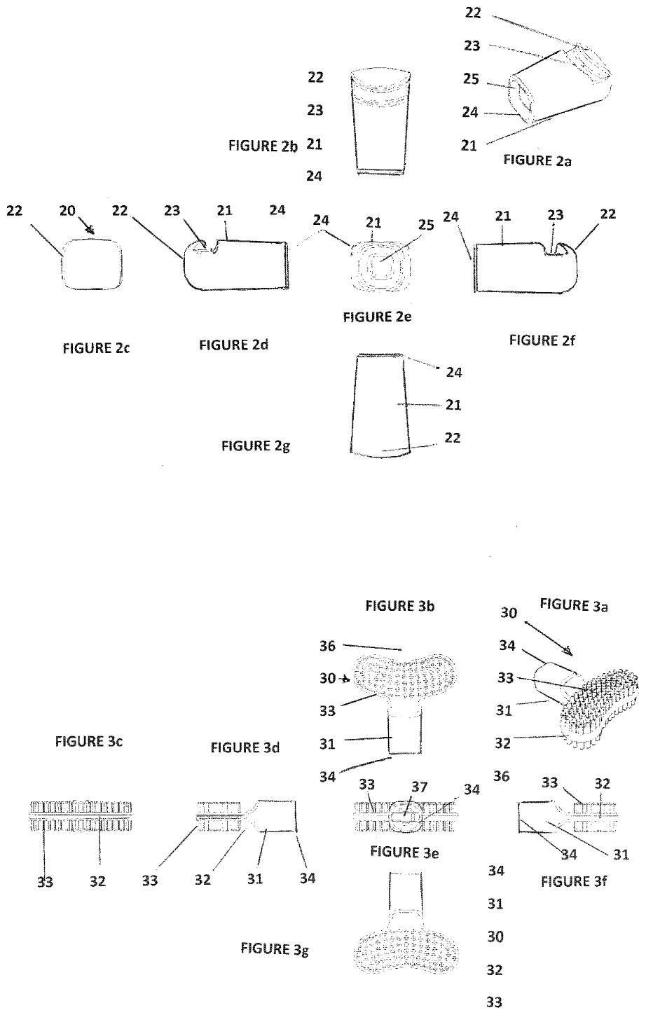

FIGS. 2a-g shows various views of a working head 20 attachable to the housing body 2 of FIG. 1. Typically the head selected includes a configuration and geometry which optimises tooth or teeth capture for each user. This may be a function of overall size, groove size and shape, material of construction and hardness. Working head 20 comprises a body 21 which terminates in distal end 22 and proximal end 24. Incorporated in head 20 is a groove 23 which interacts with the targeted tooth or teeth and assists in harnessing programmed tooth movements to ultimately facilitate improved alignment. Head 20 is typically located to engage a tooth and the user applies selected force to create and enhance the adjustment/movement objective in conjunction with vibration. The selected force is induced from the engagement of the tooth with a silicone head and enhanced by the application of the vibration. Head 20 further comprises a proximal opening or recess 25 which receives a connecting arm such as connecting arms 3, 4 or 5 of housing body 2 described in FIG. 1.

FIGS. 3 a-g shows various views of an alternative working head 30 attachable to the housing body of FIG. 1. Detachable working head 30 comprises a body 31 which terminates in distal end 36 and proximal end 34. Body 31 includes a shaped working end 36 which has included thereon an array of nodules 33 which are manufactured from an elastic or rubberised material, such as but not limited to silicone rubber, which allows elastic displacement of the nodules during use of the head 30. End 36 is contoured to best accommodate a partial dental arch shape or designed to accommodate curvature/contours which it is used with. Nodules 33 interact with the targeted tooth or teeth and assists in harnessing natural tooth movements to ultimately facilitate improved alignment. Head 30 is typically engaged with teeth and the user applies selected force (location, bite and vibration), to create and enhance the alignment therapy objectives by chewing on the nodules. Head 30 further comprises a proximal opening or recess 37 which receives a connecting arm such as connecting arms 3, 4 or 5 of housing body 2 described in FIG. 1.

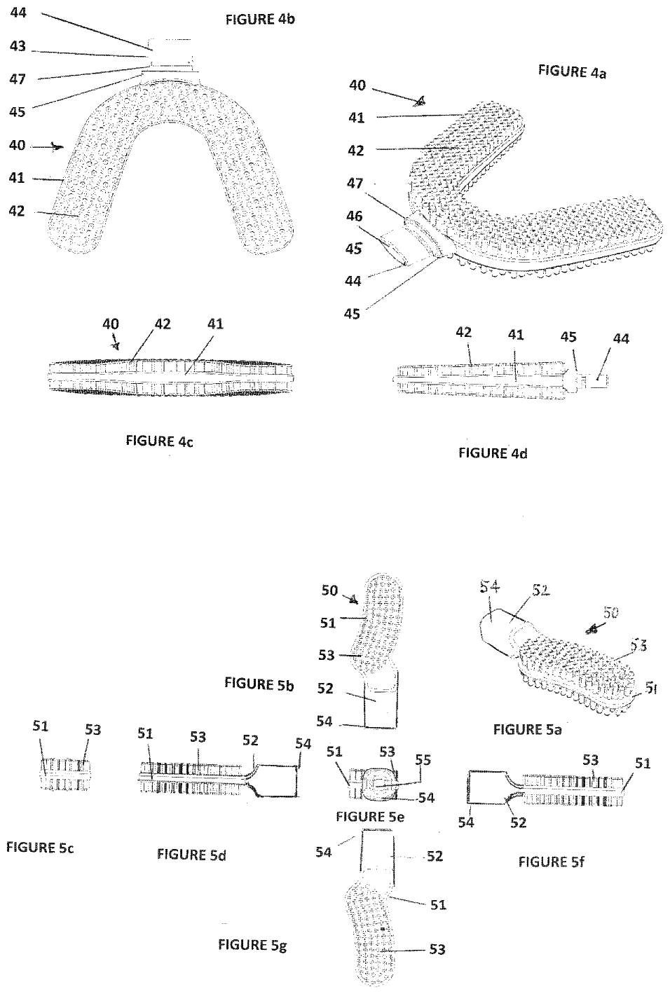

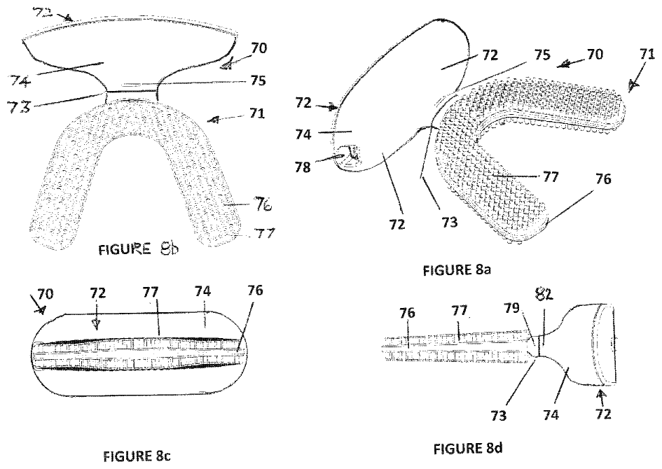

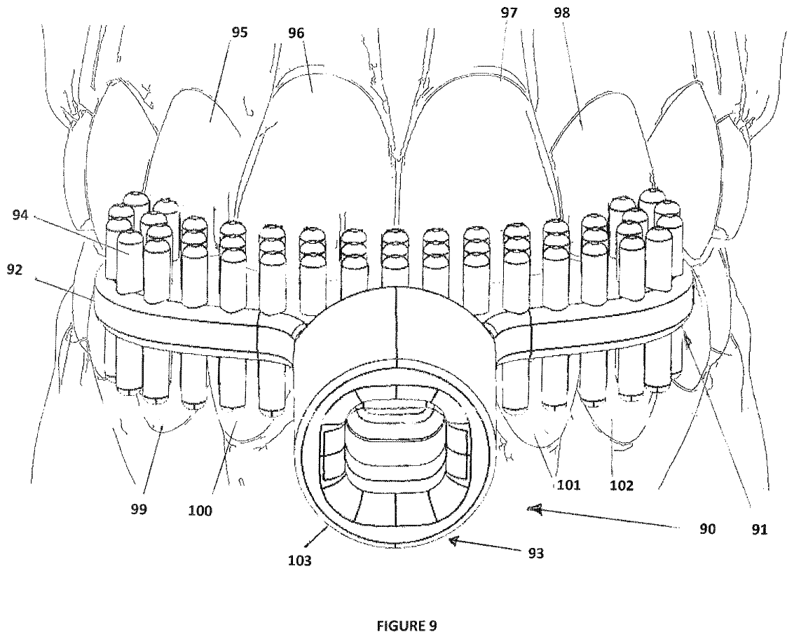

FIG. 4a-d shows an orthodontic appliance working head 40 according to an alternative embodiment. Working head 40 comprises a body 41 which is substantially arch shaped and incorporates arrays of nodules 42 which engage with the teeth of a user. Head 40 includes a flexible chassis which can be customised to a patients bite. Head 40 has a connecting arm 43 terminating at end 44 which is arranged to engage a detachable housing (described in more detail with reference to FIG. 8). Arm 43 also includes abutment surface 45 which engages an opposing surface of a housing (not shown—see item 72 of FIG. 8).

FIGS. 5a-g shows an alternative working head 50 according to an alternative embodiment capable of attachment to the housing body 2 of FIG. 1. Working head 50 comprises a body 51 which terminates in distal working end 52 and proximal end 54. Head 50 includes arrays of elastic nodules 53 which engage with the targeted tooth or teeth and assists in harnessing natural tooth movements under the action of a vibration. Head 50 is typically ‘chewed’ in that the user applies a force to create and enhance the adjustment objective in conjunction with a vibration. Head 50 further comprises at abutment end 54 a proximal opening or recess 55 which receives a connecting arm such as connecting arms 3, 4 or 5 of housing body 2 described in FIG. 1.

Nodules described herein, such as nodules 53, distribute vibrational forces to each individual tooth or teeth which is/are in contact with the nodules. The applied vibration forces include horizontal and/or vertical acceleration components which are transferred via a tooth crown through to ligaments and through to the tooth root. Since the nodules impact on each individual tooth, each tooth may be influenced separately either with or without influence from vibration and forces generated on adjacent teeth. Even where the attachment includes an array of nodules which contact multiple teeth, each tooth in the group is isolated, stimulated and acted upon separately by adjacent nodules as each tooth will normally require its own individual treatment. Upon application of a vibrational force to the tooth, forces generated include acceleration and axial forces which combine to stimulate cellular changes which influence tooth re alignments.

Factors which influence alignment correction include, frequency of vibration, size of force/s applied, geometry of the nodules, the layout of the nodules, the materials of construction of the nodules, their capacity to displace/deflect, their individual and co-operating contact with the tooth and the ability of the nodules to act on individual teeth without unwanted influence from other nodules. In the embodiments of FIG. 5, an array of like nodules 53 ise provided. Each nodule is cantilevered from and fixed to body 51 and comprises a relatively short stem which terminates at free end 56 in formation 57. When nodules 53 contact a tooth, nodules which are in contact with that tooth will undergo deformation and/or deflection to accommodate the crown geometry of the particular tooth. Since each nodule has elastic displacement and deformation capacity, a force will be applied to the tooth that those nodules are in a contact with. The deflection of the nodules at the interface between the tooth and the appliance.

This local effect of force application can be adjusted by providing an alternative nodule array and/or alternative nodule geometry. The alternative array of nodules and individual nodules can be effected by a change in the length, shape, diameter, stiffness. flexibility (elasticity), cluster density, spacing and variations in these parameters from nodule to nodule or from arrays of nodules to arrays of nodules. The appliance and nodule arrays are designed to optimise the application of mechanical and vibrational forces induced at the teeth. As a user bites into the nodules at the working end of the appliance, the nodules will locally displace to accommodate the geometry of the tooth or teeth contours that the nodules engage. Vibration is induced into the appliance and this is transmitted through the nodules stimulating the cells.

Vibrational forces are created by the motor and are initially constant. The vibrational forces are distributed through the tooth via the nodules, depending upon the nature of the interface between a nodule an the adjacent tooth. Preferred nodule height is within the range 1-10 mm and thickness within the range of 1-5 mm. It will be appreciated that sizes outside and either side of these ranges are contemplated and may be related to selection of alternative materials. Preferably, each nodule is manufactured from a relatively hard chassis over moulded with silicone nylon. The nodules are potentially spongy and displaceable but with sufficient stiffness to ensure optimal force transmission for cell stimulation, eventually influencing teeth alignment.

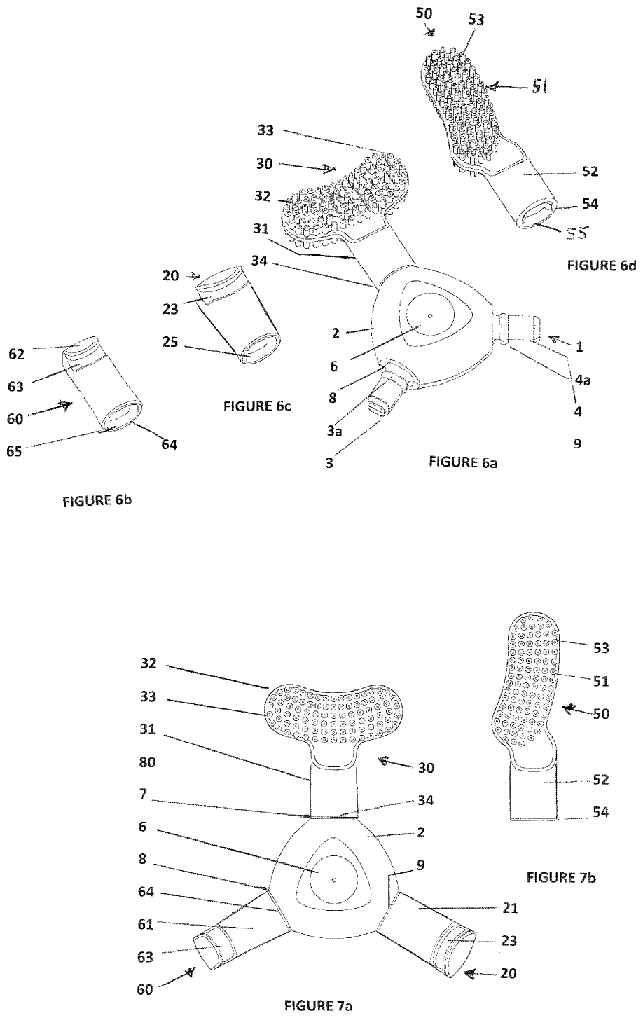

FIGS. 6a-e shows with corresponding numbering an exploded layout of the housing 1 of FIG. 1 and various working heads 20, 30, 50 and 60, selectable for attachment to the housing. Heads 20, 30 and 50 were described earlier. Head 60 is an alternative version of head 20 and operates in a similar manner to that described for working head 20. Head 60 comprises a body 61 having a distal end 62 and proximal end 64. Distal end incorporates a grove which is arranged to target a particular tooth. End 64 includes recess 65 which receives and retains one or other of arms 3, 4 or 5 of housing 1.

FIG. 7a shows with corresponding numbering an orthodontic appliance 80 fully assembled from the working heads described earlier. According to one embodiment the present invention may be provided in a kit form including a housing and an array of working heads which a user may select from. The arrangement shown in FIG. 7 has selected heads 20, 30 and 60. In this case head 50 was not selected but one of selected heads 20, 30 and 60 can be removed and head 50 (see FIG. 7b) or any other suitable working head may be inserted in its place.

Appliance 80 can be placed in a user's mouth in any one of a variety of orientations with the option of activating the vibration, using switch 6. A vibration motor may be concealed in housing body 2 along with a power source such as a battery which is rechargeable or non-rechargeable. Where a rechargeable battery is employed, recharging may be effected by induction. Alternatively a port can be provided to connect to an external power source via a lead (not shown) which may include a USB terminal. A rechargeable battery might typically last for at least 20 minutes before recharging.

It can be seen that a potentially unlimited number of head designs can be selectively attached to housing 1 depending upon particular user requirements. Typically the patient might use the appliance assembly 80 two or three times a day or according to orthodontic requirements. Since there is a relationship between vibration frequency and effectiveness of the targeting of a tooth by the selected working head, the orthodontic assembly according to the invention allows a user to select a combination of working heads and vibrational frequencies depending upon that users particular prescription for use.

The assembly therefore imparts significant user versatility and allows the selection of working head and vibration frequencies to synergistically enhance the alignment and other orthodontic objectives. According to one embodiment the vibration source may include multiple settings which allows vibrational frequency adjustments. Vibrations may also be used to enhance nerve stimulation using the assembly.

FIG. 8 shows an orthodontic appliance assembly 70 according to an alternative embodiment including a working head 71 and housing 72. Working head 71 is similar to the working head 40 arrangement described with reference to FIG. 4. Head 71 includes working end 76 which incorporates arrays of nodules 77 as describe earlier. Housing 72 comprises a body 74 retains electrics such as a motor and battery which allow vibration. Port 78 can be used to recharge a battery and/or for switching purposes. Housing 72 is capable of detachable fitment to working head 71 via junction 73 which includes click fit nodule 75. Junction 73 includes opposing abutment surfaces 79 and 82 as shown in FIG. 8d.

FIG. 9 shows a front elevation view of a working head 90 according to one embodiment located in use adjacent a patient's front teeth array 91. Detachable working head 90 comprises a body 91 which terminates in distal working end 92 and proximal end 93. Working end 92 has included thereon an array of nodules 94 which are manufactured from an elastic or rubberised material, such as, but not limited to silicone rubber, which allows elastic displacement, compression, deflection of the nodules during use of the head 90. End 92 is contoured to accommodate a dental arch shape or other required shape. Nodules 94 interact with a targeted tooth or teeth, in this example, one or more of teeth 95, 96, 97, 98, 99 100, 101, 102, assist in harnessing natural tooth movements in conjunction with applied vibration. The user applies selected force (location, bite and vibration), to create and enhance the therapy objectives enhanced by the nodules. Proximal end 93 includes a connection 103 acting as a docking port which engages a vibration source as previously described.

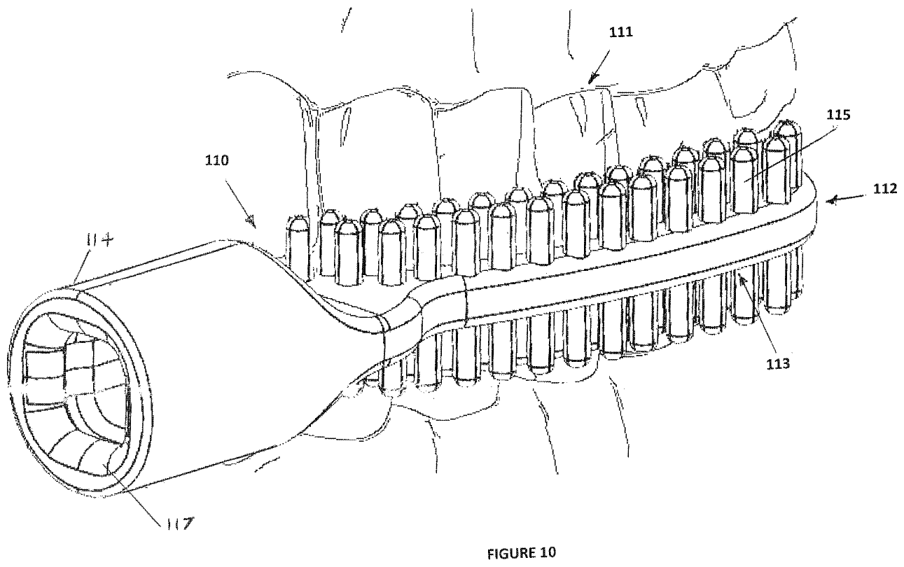

FIG. 10 shows a side elevation view of a working head 110 according to an alternative embodiment located adjacent a patient's rear teeth array 111. Detachable working head 110 comprises a body 112 which terminates in distal working end 113 and proximal end 114. Working end 113 has included thereon an array of nodules 115 which as before are manufactured from an elastic or rubberised material, and allow elastic displacement, compression, deflection of the nodules during use of the head 110. End 113 is contoured to accommodate a dental arch shape or other required shape. Nodules 115 interact with a targeted tooth or teeth as previously described herein. Proximal end 114 includes a connection 117 acting as a docking port which engages a vibration source as previously described.

In use the intra oral removable orthodontic assembly which influences teeth alignment is prepared by attaching a selected attachment of a particular shape and configuration to the seating unit or housing. The user gently bites on the attachment which brings formations such as the grooves and nodules described herein into engagement with a tooth or an array of teeth including engagement with crowns. Each tooth in an array may be engaged individually by the formations. A vibration source in the seating unit induces vibration at a selected frequency causing seating engagement of the attachment on a selected tooth or group of teeth of a wearer. The formations which may be grooves or nodules are able to undergo elastic displacement, deformation, distortion, compression, bending and in conjunction with an applied vibration influences tooth or teeth movement. A patient is asked to adopt a time regime which is arranged to best suit the individual's treatment.

In summary the method comprising the steps of:

a) selecting the attachment and attaching it to the seating unit;
b) placing the attachment at a selected location intra orally against teeth of a wearer;
c) activating the vibration source;
d) inducing a vibration by selecting a motor speed at a frequency selected for a particular patient;
e) allowing the vibration at the selected frequency or range of selected frequencies to continue for a predetermined time period while the formations such as nodules or grooves on the attachment are in contact with teeth;
f) allowing the vibration source to switch off after the predetermined time period.
It will be appreciated that alternative formations of various shapes (male or female) are contemplated beyond use of grooves and nodules, but grooves and nodules are preferred.

Each working head is capable of targeting slower moving teeth and this may be enhanced by local vibrations. The orthodontic assembly however configured for use will generally be sized to fit within a field of 100 mm×100 mm but alternative sizes are contemplated. Materials of construction for the working head may be selected from smooth, heat resistant, non reflective, semi-firm material, hard, soft, plastics/silastic, medical grade silicone, rubberised, electrically neutral and thermally inert.

Each working head and its connector may be disposable or reusable and capable of cleaning or sterilisation. Typically the appliances are provided in a kit including those with and without working heads. A kit may typically comprise a selection of working heads, a housing separated from working heads, a vibration motor insider the housing and recharging leads.

It will be appreciated by those skilled in the art that numerous variations and modifications may be made to the invention without departing from the overall spirit and scope of the invention broadly described herein.

The claims defining the invention are as follows:

1. An intra oral removable orthodontic assembly which influences teeth adjustment; the assembly comprising;
a intraoral attachment fitted to a seating unit and in use, held in place by intraoral engagement of the attachment with crowns of teeth of a wearer;
the intraoral attachment shaped to at least partially conform to at least part of a dental arch;
the seating unit including a power source, a PCB controller and a source of vibration transmissible to the attachment;
wherein said seating device vibrates in response to said source of vibration at a selected frequency between 60 Hz-130 Hz inducing a response in a selected tooth or group of teeth of a wearer; characterised in that the attachment includes a working head having an array of displaceable formations arranged to engage said teeth and responsive to said vibration.

2. An assembly according to claim 1 wherein, said intraoral attachment intraoral attachment is detachably fitted to the seating unit.

3. An assembly according to claim 2 wherein, said formations responsive to vibration comprise protrusions and extending from a surface of the attachment.

4. An assembly according to claim 3 wherein the protrusions are nodules arranged on an upper and/or lower surface provided on the attachment.

5. An assembly according to claim 4 wherein the nodules are arranged to engage 30%-50% of the crowns of a wearer.

6. An assembly according to claim 5 wherein the nodules fall within a height range of 1-10 mm.

7. An assembly according to claim 6 wherein the nodules fall within a thickness range of 1-5 mm.

8. An assembly according to claim 7 wherein the vibration induces a force on the intra oral attachment to facilitate seating of said nodules on said teeth crowns.

9. An assembly according to claim 8 wherein the intraoral attachment is shaped and sized for targeting a selection of teeth in a teeth arch of a wearer of the attachment.

10. An assembly according to claim 9 wherein said intraoral attachment engages the clinical crowns of the teeth.

11. An assembly according to claim 10 wherein the dental arch is a quadrant

12. An assembly according to claim 11 wherein the intraoral attachment is shaped to engage anterior maxillary and mandibular teeth;

13. An assembly according to claim 12 wherein said intraoral attachment is interchangeable with another intraoral attachment on the seating unit.

14. An assembly according to claim 13 wherein said intraoral attachment is made from viscoclastic medical grade silicone.

15. An assembly according to claim 14 wherein elasticity in said silicone enables close engagement of the intraoral attachment with all clinical crowns of the teeth in a selected teeth array.

16. An assembly according to claim 15 wherein said vibration source comprises a motor which operates at 3 speeds.

17. An assembly according to claim 16 wherein said power source is a battery.

18. An assembly according to claim 17 wherein said battery is rechargeable.

19. An assembly according to claim 18 wherein the battery is charged using an induction charger housed within the casing of the seating unit.

20. An assembly according to claim 19 wherein the seating unit automatically switches off after a predetermined time period.

21. An assembly according to claim 20 wherein the seating unit automatically switches off after a two minute time period.

22. An intra oral removable orthodontic assembly which influences teeth alignment and provided in the form of a kit; the kit comprising a central seating unit including a housing defining an internal space, and extending from the housing at least one connection configured to receive and retain thereon a detachable intraoral attachment; the kit including a selection of intraoral attachments;
each said detachable intraoral attachment shaped to conform to at least part of a dental arch;
the seating unit including, a power source, a PCB controller and a source of vibration;
wherein said seating device vibrates in response to said source of vibration at a selected frequency between 60 Hz-130 Hz causing location of the attachment on a selected group of teeth of a wearer; characterised in that the attachment includes a working head having an array of formations arranged to engage said teeth influenced by said vibration.

23. An assembly according to claim 22 wherein, said formations comprise displaceable nodules protruding from a top and/or bottom surface provided on the detachable attachment.

24. An assembly according to claim 23 wherein the nodules are arranged to engage 30%-50% of the crowns of a wearer;

25. An assembly according to claim 24 wherein said intraoral attachment is interchangeable with another intraoral attachment on the seating unit.

26. An assembly according to claim 25 wherein said intraoral attachment is made from viscoelastic medical grade silicone.

27. An assembly according to claim 26 wherein said power source is a battery.

28. An assembly according to claim 27 wherein said battery is rechargeable.

29. An assembly according to claim 28 wherein said vibration source comprises a motor which operates at 3 speeds;

30. An assembly according to claim 29 wherein the battery is charged using an induction charger housed within the casing of the seating unit.

31. An intra oral removable orthodontic assembly which influences teeth movement and adjustment, the assembly comprising a central seating unit including a housing defining an internal space, and extending therefrom a connection configured to receive and retain thereon a detachable intraoral attachment providing a working head;
the seating unit including a source of vibration;
wherein said seating unit vibrates in response to said source of vibration at a selected frequency; the vibration influencing engagement of the attachment with a selected group of teeth of a wearer; characterised in that the attachment includes a working head having an array of displaceable nodules arranged to engage said teeth and responsive to vibrations from said source of vibration.

32. An intra oral removable orthodontic assembly according to claim 31
wherein the detachable intraoral attachment is shaped to conform to a dental arch;

33. An intra oral removable orthodontic assembly according to claim 32 further comprising in the housing a power source, a PCB controller

34. An intra oral removable orthodontic assembly according to claim wherein the attachment is selected from a selection of intraoral attachments.

35. An intra oral removable orthodontic assembly according to claim 34 wherein the seating device vibrates in response to said source of vibration at a selected frequency between 60 Hz-130 Hz

36. An intra oral removable orthodontic assembly according to claim 22 wherein there are a plurality of formations comprising nodules, grooves which induce force against teeth thereby accelerating alignments.

37. An intra oral removable orthodontic assembly according to claim 36
wherein the nodules interact with a tooth or teeth and optimally harness teeth movement forces to enhance prescribed orthodontic tooth movement.

38. A method for correcting the alignment of teeth, using an intra oral removable orthodontic assembly which influences teeth alignment; the assembly comprising;
an intraoral attachment detachably fitted to a seating unit, the attachment held in place in use by engagement between the intraoral attachment and crowns of teeth of a wearer;
the detachable intraoral attachment shaped to conform to a dental arch;
the seating unit including a source of vibration;
wherein said seating device vibrates in response to said source of vibration at a selected frequency causing seating of the attachment on a selected group of teeth of a wearer: characterised in that the attachment includes a working head having an array of nodules arranged to engage said teeth;
the method comprising the steps of:
a) selecting the attachment and attaching it to the seating unit;
b) placing the attachment at a selected location intra orally against teeth of a wearer;
c) activating the vibration source;
d) inducing a vibration by selecting a motor speed at a frequency selected for a particular patient;
e) allowing the vibration at the selected frequency or range of selected frequencies to continue for a predetermined time period while the nodules of the attachment are in contact with teeth;
f) allowing the vibration source to switch off after the predetermined time period.

39. A method according to claim 38 comprising the further step of applying the vibration at a frequency range between 60 Hz-130 Hz.

40. An assembly according to claim 3 wherein the protrusions are grooves arranged on an upper and/or lower surface provided on the attachment.
